(19) United States
(12) Patent Application Publication
(10) Pub. No.: US 2009/0200281 A1
(43) Pub. Date: Aug. 13, 2009

(54) WELDING POWER SUPPLY WITH NEURAL NETWORK CONTROLS

(75) Inventor: Jay Hampton, Lenox, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/028,428

(22) Filed: Feb. 8, 2008

(51) Int. Cl. B23K 9/095; G01M 19/00

(52) U.S. Cl. 219/130.33; 219/130.01; 73/865.8

(57) ABSTRACT

A method controls a welding apparatus by using a neural network to recognize an acceptable weld signature. The neural network recognizes a pattern presented by the instantaneous weld signature, and modifies the instantaneous weld signature when the pattern is not acceptable. The method measures a welding voltage, current, and wire feed speed (WFS), and trains the neural network using the instantaneous weld signature when the instantaneous weld signature is different from each of the different training weld signatures. A welding apparatus for controlling a welding process includes a welding gun, a power supply for supplying a welding voltage and current, and a sensor for detecting values of a plurality of different welding process variables. A controller of the apparatus has a neural network for receiving the welding process variables and for recognizing a pattern in the weld signature. The controller modifies the weld signature when the pattern is not recognized.

### TECHNICAL FIELD

The invention relates generally to a method and apparatus for controlling a power supply for a welding process using a neural network control model or a neural processor.

### BACKGROUND OF THE INVENTION

Welding systems are utilized extensively in various manufacturing processes to join or bond various work surfaces. Arc welding systems in particular may be used to strongly fuse or merge separate work surfaces into a unified body via the controlled application of intense heat and an intermediate material to form a resultant weld joint. A strong metallurgical bond forms when the intermediate material, which is quickly rendered molten in the presence of a high temperature arc during the arc welding process, ultimately cools and solidifies. Ideally, the resultant weld joint has approximately the same overall strength and other material properties as the originally separate work surfaces.

In an arc welding process, the arc may be formed between the work surface and a consumable electrode, such as length of wire, which is controllably fed to a welding gun while the welding gun moves along the welding joint, with the arc being transmitted via an ionized column of arc shielding gas. The arc itself provides the intense levels of heat necessary for melting the consumable electrode or wire. The electrode thus conducts electrical current between the tip of the welding gun and the work surface, with the molten wire material acting as a filler material when supplied to the weld joint.

Welding process controllers typically contain generic weld signatures having feedback loops for the arc current, voltage, and/or other parameters, and provide a limited ability to change particular portions of the waveform. Specialized software for developing custom weld signatures for a particular welding process may be less than optimal due to the high level of expertise required for developing the waveforms, as well as the extensive testing and process validation associated with implementing such custom software in a given welding process.

### SUMMARY OF THE INVENTION

Accordingly, a method is provided for controlling a welding apparatus, including training a neural network to recognize an acceptable weld signature by exposing the neural network to different training weld signatures, then monitoring an instantaneous weld signature. The method uses the neural network to recognize a pattern presented by the instantaneous weld signature, and selectively modifies the instantaneous weld signature when the neural network determines that the pattern is not an acceptable weld signature.

In one aspect of the invention, the method monitors the instantaneous weld signature by continuously measuring a welding voltage, a welding current, and a wire feed speed (WFS) of the welding apparatus.

In another aspect of the invention, the method selectively modifies the instantaneous weld signature by selectively modifying at least one waveform used for controlling the welding voltage, the welding current, and/or the wire feed speed.

In another aspect of the invention, the method determines if the instantaneous weld signature is sufficiently different from each of the plurality of different training weld signatures, and then trains the neural network using the instantaneous weld signature when the instantaneous weld signature is sufficiently different from each of the different training weld signatures.

In another aspect of the invention, the method determines if the instantaneous weld signature is sufficiently different from each of the different training weld signatures, and discards the instantaneous weld signature when the instantaneous weld signature is determined to be insufficiently different from each of the different training weld signatures.

In another aspect of the invention, a method controls a weld signature during a welding process by monitoring a weld signature describing welding process control variables, including a welding voltage, a welding current, and a wire feed speed (WFS). The method processes the weld signature through a neural network to determine whether the weld signature has a pattern that is consistent with at least one training weld signature, and continuously and automatically modifies at least one of the welding process control variables when the pattern is inconsistent with the at least one training weld signature.

In another aspect of the invention, the method compares the weld signature to the different training weld signatures stored in a training signature database, and determines if the weld signature is sufficiently different from each of the training weld signatures stored in the database. The method then records the weld signature in the database when the weld signature is sufficiently different from each of the different training weld signatures.

In another aspect of the invention, the method tests a weld joint after classifying to thereby determine a set of weld data containing the values of each of a plurality of different weld joint properties, and then correlates the weld signature with the set of weld data to validate the database.

In another aspect of the invention, an apparatus is provided for controlling a welding process, and includes a welding gun for forming a weld joint, a power supply for supplying a welding voltage and a welding current for selectively powering the welding gun, and at least one sensor for detecting values of a plurality of different welding process variables. The variables include the welding voltage, welding current, and a wire feed speed (WFS) corresponding to a speed of a length of welding wire that is consumable in the formation of the welding joint. The apparatus also includes a controller having a neural network for receiving the values of the welding process variables and recognizing a pattern in the weld signature, the pattern corresponding to a predicted quality of the welding joint. The controller continuously and automatically modifies at least one of the values of the welding process variables to thereby modify the weld signature when the pattern is not recognized.

In another aspect of the invention, the controller is in communication with a database containing a plurality of different training weld signatures each corresponding to a welding joint having a predetermined acceptable weld quality.

In another aspect of the invention, the neural network has an input layer with various input nodes each corresponding to a different one of the welding process variables.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a welding apparatus and a controller operable for controlling a welding process according to the invention;

FIG. 2A is a graphical representation of a welding current control waveform;

FIG. 2B is a schematic representation of a weld droplet transfer process as it relates to the welding current control waveform of FIG. 2A;

FIG. 3 is a schematic representation of an artificial neuron model or neural network usable with the controller shown in FIG. 1;

FIG. 4 is a graphical representation of a weld signature usable with the controller of FIG. 1; and

FIG. 5 is a graphical flow chart describing a method for controlling a welding process using the neural network of FIG. 3.

### DESCRIPTION OF THE PREFERRED EMBODIMENTS

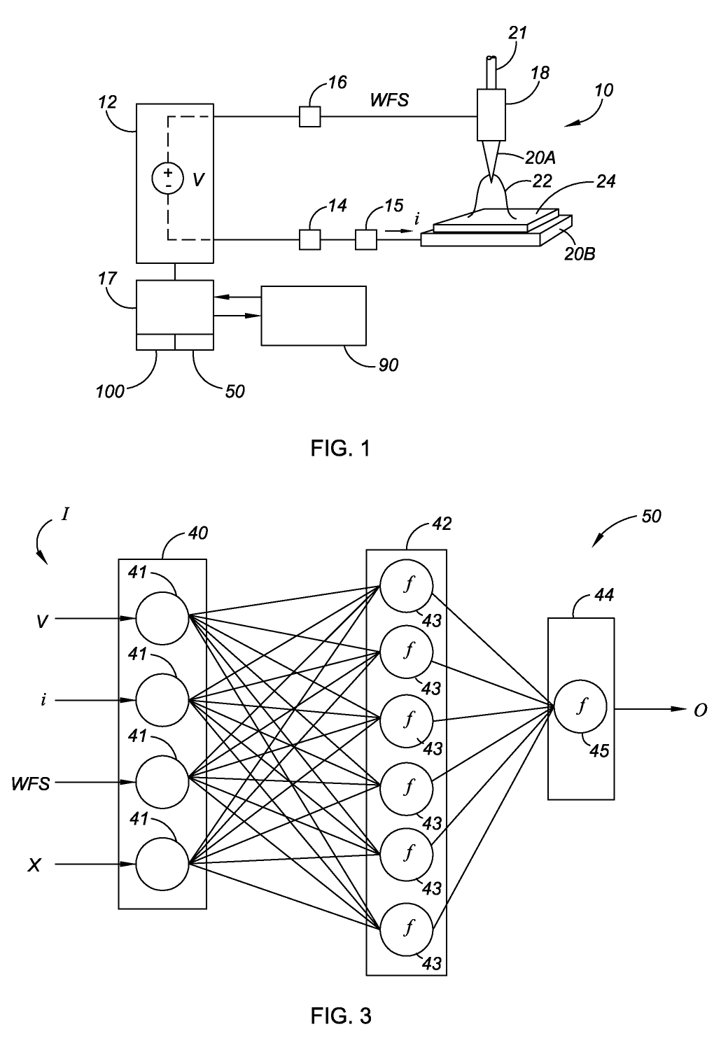

Referring to the drawings, wherein like reference numbers correspond to like or similar components throughout the several figures, and beginning with FIG. 1, an apparatus and method for controlling a weld signature during a welding process is provided herein. The method and apparatus may be used in a variety of different welding processes, including but not limited to single work piece operations, joining two or more work pieces or surfaces together, and/or for joining two ends of a single work piece together. Accordingly, the welding apparatus 10 includes an automated or manual welding device or welding gun 18, which is operatively connected to a robotic or manually repositionable arm 21, to an integrated control unit or controller 17, and to a power supply 12 that is operable for generating or providing a welding voltage (V) and a welding current (i). A plurality of sensors 14, 15, and 16, which may alternately be configured as a single sensor and/or housed together in a common sensor housing (not shown), are adapted for sensing, measuring, detecting, and/or otherwise determining the values over time of one or more dynamically changing welding process variables, which as a whole define the total or combined “weld signature”, as that term will be described in detail hereinbelow.

The weld gun 18 is configured for selectively completing a welding operation, such as, but not limited to, metal inert gas (MIG) or tungsten inert gas (TIG) arc welding or other welding operations suitable for forming a high-temperature arc 22 at or along one or more weld points or joints of a work piece 24. The weld gun 18 may be mounted to a robot arm (not shown) in a repositionable and re-orientable manner, such as by selective pivoting and/or rotation. The welding apparatus 10 includes at least one electrode 20A, which may be a consumable length of welding wire, and an electrode 20B, shown as a plate on which the work piece 24 is positioned, with the electrodes 20A, 20B being positioned generally opposite one another when the weld gun 18 is active. The arc 22 can melt a portion of the electrode 20A, such as a consumable length of welding wire, and in this manner form the weld joint.

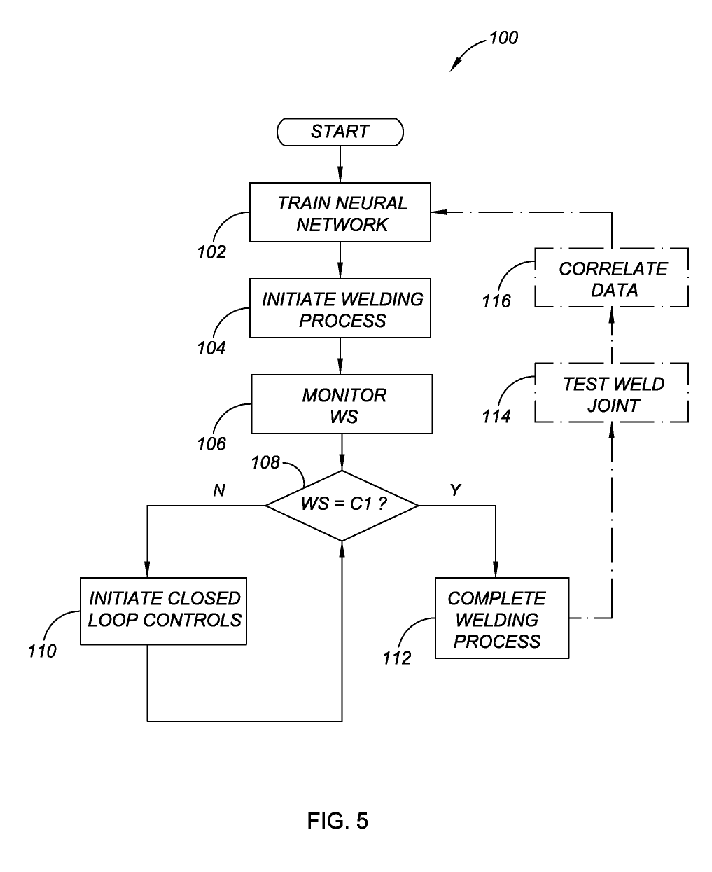

In accordance with the invention, the controller 17 includes a neural network 50 (also see FIG. 3) which is trainable using a training signature database 90 that is populated with a sufficient number of validated, i.e., predetermined “acceptable” or “good” weld signatures, as described later hereinbelow. The controller 17 also includes an adaptive welding process control method 100, as will be described with reference to FIG. 5, for using the neural network 50 to control and/or adapt the active or instantaneous weld signature, i.e., the weld signature corresponding to an active and ongoing weld process, in real-time. In this manner, the controller 17 allows for continuous monitoring and modification of the weld signature in order to conform to a learned “acceptable” weld signature profile without requiring extensive programming or algorithm modification. The neural network 50 allows for the generation of a wide variety of weld signatures, including weld signatures that can automatically and continuously adapt to changes in welding conditions. Also, the extensive testing and validation that are normally required for developing unique weld signatures for each different weld process is minimized, and the weld quality is optimized.

In accordance with the invention, the method 100 of FIG. 5 discussed below utilizes the neural network 50 (also see FIG. 3) as an information processing paradigm which is able to look, in real-time, at a total or combined set of detectable or measurable welding process variables, collectively referred to hereinafter as the weld signature, and to determine or recognize whether a particular pattern represented by the weld signature is acceptable, good, or passing, or unacceptable, bad, or failing, according to a predetermined set of weld quality criteria. The neural network 50 is initially trained during a controlled training process, for example by subjecting or exposing the neural network 50 to a plurality of training weld signatures each corresponding to an acceptable weld signature, as will be understood by those of ordinary skill in the art. The neural network 50 is also continuously trainable by exposing the neural network 50 to additional acceptable weld signatures over time to further develop and refine the pattern-recognition accuracy of the neural network 50, as will be described below.

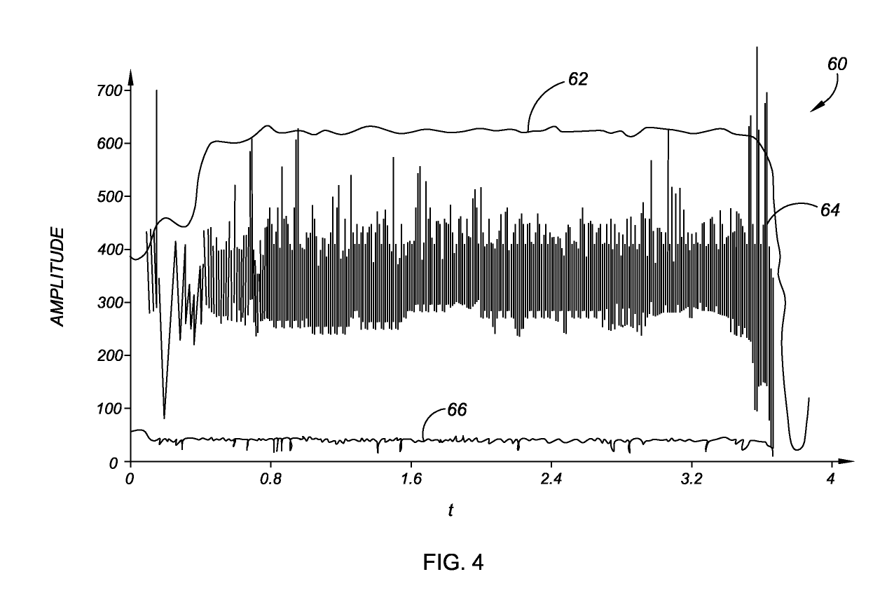

As will be understood by those of ordinary skill in the art, neural networks such as the neural network 50 of FIG. 3 may be used to predict a particular result and/or to recognize a pattern that is presented by less than optimal, imprecise, and/or relatively complex set of input data. For example, such a complex set of input data set may consist of the more typical welding process variables, i.e. the welding voltage V, the welding current i, and the wire feed speed (WFS) as described above, and/or other such dynamically changing input variables, as will be described later below with reference to FIG. 4. Likewise, the neural network 50 may be used by the controller 17 to continuously monitor a weld signature against a learned “acceptable” waveform, and using this information, continuously and automatically adapt one or more parameters of a given weld signature to bring the welding process back under control, i.e. to conform the weld signature to a waveform that is consistent with the learned acceptable waveforms.

As stated above, neural networks are operable for adapting or “learning” via repeated exposure to different training sets, such as any supervised or unsupervised input data sets, and are operable for dynamically assigning appropriate weights and/or relative significance values to each of the various different pieces of information constituting the input data set. Neural networks are generally not pre-programmed to perform a specific task, such as with various control algorithms that may utilize a preset max/min threshold limit for each distinct parameter or value without in any way predicting or classifying the total or overall monitored weld signature. Instead, neural networks, such as the neural network 50 of FIGS. 1 and 3, utilize associative memory to effectively generalize about the totality or universe of the combined input set to which the neural network is subjected, such as the welding system input set “I” shown in FIG. 4. In this manner, a properly trained neural network may be able to accurately and consistently predict a future condition from past experience, classify a complex data set as required, as represented by the arrow O in FIG. 3, and/or recognize an overall pattern presented by the totality of the complex data set, which might otherwise require substantial time and/or expertise to properly decipher.

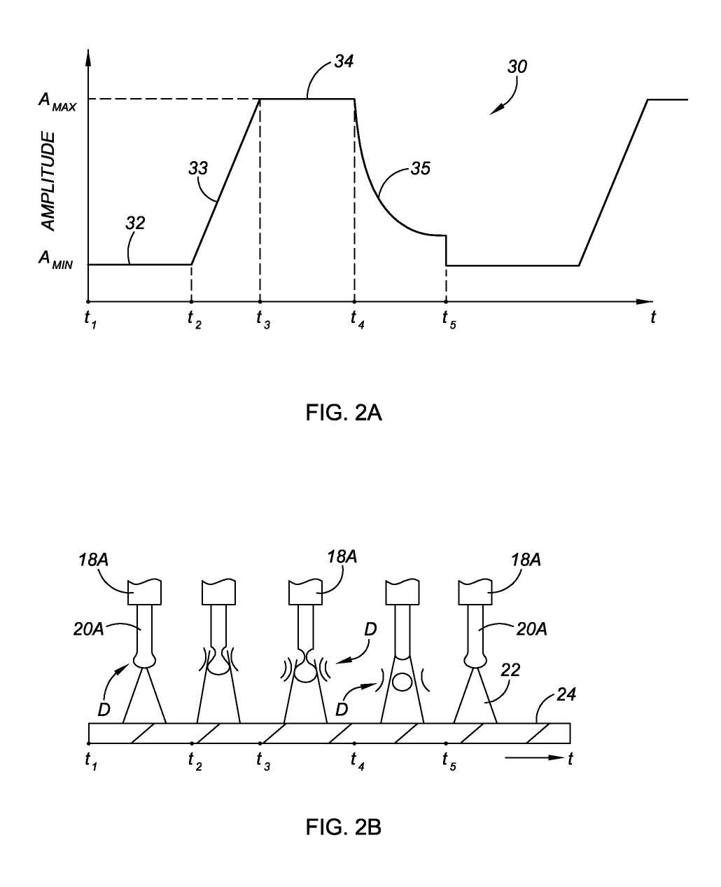

Referring to FIGS. 2A and 2B, one variable of such a complex input data set described above may be embodied herein as an exemplary welding current waveform 30 of FIG. 2A. The waveform 30 in FIG. 2A describes one cycle of a single welding process control variable or weld control waveform, in this instance the welding current i (see FIG. 1), and the schematic illustration of FIG. 2B describes how the waveform 30 of FIG. 2A may affect an associated weld droplet transfer from a nozzle or tip 18A of the weld gun 18 (see FIG. 1). The waveform 30 may be measured using the sensor 14 of FIG. 1.

In FIG. 2A, the line 32 represents the baseline or background amperage level or amplitude of the welding current i of FIG. 1, i.e. A_{MIN}. As shown in FIG. 2B beginning at t₁, while the welding current i is held at A_{MIN}, the weld droplet (D) remains partially formed at an end of the welding wire or electrode 20A and in contact with the arc 22. However, as the waveform 30 of FIG. 2A reaches t₂, line 33 quickly ramps to the level of line 34, i.e. the peak amperage or A_{MAX}. This ramp in amperage causes the arc 22 to liquefy or melt a portion of the electrode 20A when configured as a welding wire, and the weld droplet (D) begins to separate from the electrode 20A. A_{MAX} is then held until t₄, and the weld droplet (D) fully separates from the electrode 20A. Curve 35, or the tailout, immediately follows, with the contour of curve 35 largely determining or influencing the dynamics of the weld droplet (D) as it descends toward the work piece 24.

As discussed above, FIGS. 2A and 2B represent just one example of a welding process control variable or parameter, i.e. the welding current i. Other possible welding process control variables or parameters include welding voltage (V), wire feed speed (WFS), physical composition of the work piece 24 of FIGS. 1 and 2B, arc shielding gas composition, etc. In the waveform 30 of FIG. 2A, an operator must program at least the ramp-up rate of line 33, the tailout time of curve 35, peak amperage or A_{MAX}, background amperage or A_{MIN}, peak time or duration of line 34, background time or duration of line 32, and the frequency of the waveform 30. Additional variables each require a similar number of programmed control parameters, quickly adding to the potential complexity of parameter-based welding process control.

The particular control waveform for a given weld process may be unique even for identical models or types of welding apparatuses 10 (see FIG. 1), due to the unique physical and environmental influences affecting each particular welding process. Accordingly, pre-programmed waveforms that may be provided with a typical controller are largely generic, or in some cases may provide a limited ability to selectively modify the values of a number of parameters, such as amplitude of the welding current i (see FIG. 1), but otherwise such waveforms may not be optimized for each welding apparatus 10 using such generic waveforms.

Accordingly, and referring to FIG. 3, the neural network 50 described generally above is programmed, stored in, or otherwise accessible by the controller 17 (see FIG. 1), and is usable by the method 100 (see FIGS. 1 and 5) to accurately predict, classify, or otherwise recognize a pattern in a weld signature, such as is exemplified in FIG. 4. The neural network 50 includes at least one input layer 40 having a plurality of different input neurons or input nodes 41, each configured to receive data, measurements, and/or other predetermined information from outside of the neural network 50. As shown in FIG. 3, in one embodiment this information or input set I includes, but is not limited to, the welding voltage V, the welding current i, and the wire feed speed or WFS, each of which is also shown in FIG. 1. At least one additional input node 41 may be configured to receive additional piece of input data, a measurement, or other process information as needed, as represented by the variable X. For example, the input variable X may correspond to a particular composition of arc shielding gas used in an arc welding process.

The neural network 50 further includes at least one “hidden” layer 42 containing a plurality of hidden neurons or hidden nodes 43 that each receive and pass along information that is output from the input nodes 41 of the input layer 40, with the hidden nodes 43 passing along the processed information to other neurons or nodes of one or more additional hidden layers (not shown) if used, or directly to an output layer 44. The output layer 44 likewise contains at least one output neuron or output node 45 that communicates or transmits information outside of the neural network 50, such as to the indicator device 11 (see FIG. 1) and/or to the training database 90 (see FIG. 1) as determined by the method 100, which is described below with reference to FIG. 5.

In the representative embodiment of FIG. 3, each of the neurons or nodes 43, 45 of the hidden layer 42 and the output layer 44, respectively, may employ a tan-sigmoidal transfer or activation function as shown, but may alternately employ a linear activation function and/or other types of sigmoidal or other activation functions as desired, and/or different numbers of hidden layers 42 and/or nodes 43, 44, in order to achieve the desired level of predictive accuracy depending on the particular output (arrow O) required. In one embodiment, the neural network 50 is initially trained using the known Levenberg-Marquardt back-propagation algorithm, but training is not so limited, with any other suitable training method or algorithm being usable with the invention.

Referring to FIG. 4, a representative weld signature 60 includes a plurality of different traces 62, 64, and 66, and may include additional traces depending on the particular input set I (see FIG. 3) being utilized by the neural network 50 of FIGS. 1 and 3. Trace 62 represents the wire feed speed (WFS) as determined by the sensor 16 of FIG. 1. Trace 64 represents the welding current (i) as determined by the sensor 15 of FIG. 1. Trace 66 represents the welding voltage (V) as determined by the sensor 14 of FIG. 1. As shown in FIG. 4, the weld signature 60 is simplified for the purpose of illustration, and may include significantly more variance in the traces 62, 64, and 66, and/or additional traces, depending on the particular application. In accordance with the invention, it is the total or combined weld signature 60, and not the individual traces 62, 64, 66 comprising the weld signature 60, that are used by the controller 17 (see FIG. 1) and the neural network 50 (see FIGS. 1 and 3) in controlling the welding process, as will now be described with reference to FIG. 5.

Referring to FIG. 5, the method 100 of the invention begins with step 102. Step 102 includes at least a preliminary neural network training process, as that term will be understood by those of ordinary skill in the art, wherein the neural network 50 of FIG. 3 is trained to quickly and accurately recognize a pattern in an instantaneous weld signature corresponding to a predicted passing, good, or otherwise acceptable weld. An acceptable weld is initially determined by validating a resultant weld joint, i.e. a weld joint meeting a predetermined set of criteria for quality, strength, uniformity, and/or other desirable properties or qualities, as described above. Step 102 may be conducted by exposing or subjecting the neural network 50 of FIG. 3 to a number of sufficiently different or varied acceptable weld signatures, such as is represented in FIG. 4. Generally, the greater the number of training data sets presented to a neural network, and the greater the variety of these data sets from one another, the more accurate the classification or pattern recognition by, and/or predictive value of, of the neural network. After properly training the neural network 50 in this manner, the method 100 proceeds to step 104.

At step 104, the method 100 initiates the welding process, with the power supply 12 of FIG. 1 providing the welding voltage V, the welding current i, and ultimately determining the wire feed speed (WFS) to form a particular weld joint. Once the welding process has been initiated, the method 100 proceeds to step 106.

At step 106, the input data set I (see FIG. 3) determining the weld signature (WS) is directed into the input layer 40 of the neural network 50 shown FIG. 3. The neural network 50 then dynamically assigns weights to the various variables comprising the input data set I, and references any associated data matrices and/or training sets of the training database 90 (see FIG. 1) that might be used by the neural network 50, to thereby monitor the instantaneous weld signature, abbreviated WS in FIG. 5. The method 100 then proceeds to step 108.

At step 108, the neural network 50 recognizes a pattern in the instantaneous weld signature (WS), with the accuracy of the pattern recognition being largely dependent upon the quality of the training performed previously at step 102. If the neural network 50 (see FIGS. 1 and 3) recognizes an acceptable pattern in the weld signature, i.e. predicts that the instantaneous weld signature (WS) corresponds to or is consistent with a learned “acceptable” weld signature to a sufficiently high confidence level relative to the various training waveforms contained in the training waveform database 90 (see FIG. 1), the method 100 proceeds to step 110. Otherwise, the method 100 proceeds to step 112.

At step 110, having determined at step 108 that the pattern of the instantaneous weld signature (WS) is insufficiently close to the learned “acceptable” weld signature, the method 100 automatically initiates closed-loop controls or an error feedback loop to bring the weld signature (WS) into control. That is, the controller 17 of FIG. 1 automatically and continuously modifies at least one of the values describing one or more of the welding process control variables or input data set I of FIG. 3 as necessary, to thereby influence or adapt the instantaneous weld signature (WS). The closed-loop controls continue or the error-adjustment loop continuously repeats until the neural network 50 once again recognizes a pattern of the instantaneous weld signature (WS) corresponding to an acceptable weld signature, as determined at step 102. Once the pattern of the instantaneous weld signature (WS) is determined to be acceptable, the method 100 proceeds to step 112.

At step 112, the method 100 completes the weld or finishes the weld joint, and the method 100 is complete for that weld joint. The method 100 may optionally proceed to step 114, and/or complete step 114 on a scheduled or a sampled basis, as needed.

At step 114, the method 100 includes subjecting a set of weld joints (not shown) to testing, such as by breaking or cutting the weld joint to precisely determine the strength, uniformity, and/or other physical properties of the weld joint. The set of test data is then recorded in the controller 17 (see FIG. 1), and the method 100 proceeds to step 116.

At step 116, the method 100 correlates the test data from step 114 to a particular weld signature (WS) that is stored in the controller 17. That is, each weld process is preferably tracked and recorded in the controller 17 so that each weld signature may be tracked to or correlated with a particular weld joint. If the weld signature corresponding to a set of test data indicates the weld joint is acceptable, and if the weld signature is sufficiently different from the existing set of training waveforms in the training database 90 (see FIG. 1), the method 100 includes recording the correlated weld signature in the training database 90 to thereby improve the accuracy of the neural network 50 (see FIG. 3).

In accordance with the invention, the controller 17 and training database 90 of FIG. 1 are used to control a particular welding apparatus 10 (see FIG. 1) for a specific application. Over time, the training database 90 will evolve to accurately reflect the unique welding process conditions for that particular welding apparatus 10. In this manner, the quality of a particular welding process may be optimized for each welding apparatus 10.

While the best mode for carrying out the invention have been described in detail, those familiar with the art to which this invention relates will recognize various alternative designs and embodiments for practicing the invention within the scope of the appended claims.

1. A method for controlling a welding apparatus, the method comprising:
training a neural network to recognize an acceptable weld signature by exposing said neural network to a plurality of different training weld signatures;
monitoring an instantaneous weld signature;
using said neural network for recognizing a pattern presented by said instantaneous weld signature; and
selectively modifying said instantaneous weld signature when said neural network determines that said pattern does not correspond to said acceptable weld signature.

2. The method of claim 1, wherein said monitoring an instantaneous weld signature includes continuously measuring a welding voltage, a welding current, and a wire feed speed (WFS) of the welding apparatus.

3. The method of claim 2, wherein said selectively modifying said instantaneous weld signature includes selectively modifying at least one waveform used for controlling said welding voltage.

4. The method of claim 2, wherein said selectively modifying said instantaneous weld signature includes selectively modifying at least one waveform used for controlling said welding current.

5. The method of claim 2, wherein said selectively modifying said instantaneous weld signature includes selectively modifying at least one waveform used for controlling said wire feed speed (WFS).

6. The method of claim 1, further comprising:
determining if said instantaneous weld signature is sufficiently different from each of said plurality of different training weld signatures; and
training said neural network using said instantaneous weld signature when said instantaneous weld signature is determined to be sufficiently different from each of said plurality of different training weld signatures.

7. The method of claim 1, further comprising:
determining if said instantaneous weld signature is sufficiently different from each of said plurality of different training weld signatures; and
discarding said instantaneous weld signature when said instantaneous weld signature is determined to be insufficiently different from each of said plurality of different training weld signatures.

8. A method for controlling a weld signature during a welding process, the method comprising:
monitoring a weld signature during the welding process, said weld signature describing a plurality of welding process control variables including a welding voltage, a welding current, and a wire feed speed (WFS);
processing the weld signature through a neural network to determine whether said weld signature has a pattern that is consistent with at least one training weld signature; and
continuously and automatically modifying at least one of said welding process control variables of the weld signature when said pattern is inconsistent with said at least one training weld signature.

9. The method of claim 8, further comprising:
discontinuing said continuously and automatically modifying when said pattern is consistent with said at least one training weld signature.

10. The method of claim 8, further comprising:
comparing the weld signature to said plurality of different training weld signatures stored in a training signature database;
determining if the weld signature is sufficiently different from each of said plurality of training weld signatures stored in said database; and
recording the weld signature in said database when the weld signature is determined to be sufficiently different from each of said different training weld signatures.

11. The method of claim 10, further comprising:
testing a weld joint after said classifying to thereby determine a set of weld data containing the values of each of a plurality of different weld joint properties; and
correlating the weld signature with said set of weld data to thereby validate said database.

12. An apparatus for controlling a welding process comprising:
a welding gun operable for forming a weld joint;
a power supply configured for supplying a welding voltage and a welding current for selectively powering said welding gun;
at least one sensor for detecting values of a plurality of different welding process variables, including said welding voltage, said welding current, and a wire feed speed (WFS) corresponding to a speed of a length of welding wire that is consumable in the formation of the welding joint; and
a controller having a neural network adapted for receiving said values of said plurality of welding process variables and for recognizing a pattern in the weld signature, said pattern corresponding to a predicted quality of the welding joint;
wherein said controller is operable for continuously and automatically modifying at least one of said values of said plurality of welding process variables to thereby modify the weld signature when said pattern is not recognized.

13. The apparatus of claim 12, controller is in communication with a database containing a plurality of different training weld signatures each corresponding to a welding joint having a predetermined acceptable weld quality.

14. The apparatus of claim 12, wherein said neural network has an input layer having a plurality of input nodes each corresponding to a different one of said plurality of different welding process variables.
